(19) United States
(12) Patent Application Publication
(10) Pub. No.: US 2026/0004265 A1
(43) Pub. Date: Jan. 1, 2026

(54) INFORMATION PROCESSING APPARATUS, INFORMATION PROCESSING METHOD, AND STORAGE MEDIUM

(71) Applicant: TOYOTA JIDOSHA KABUSHIKI KAISHA, Toyota-shi (JP)

(72) Inventors: Keisuke ISOMURA, Kariya-shi (JP); Tatsuhiko SASAKI, Toyota-shi (JP); Iwao NITTA, Nagoya-shi (JP); Aya OHKUBO, Nisshin-shi (JP); Sotaro HAYASHI, Okazaki-shi (JP); Masahiro KAGAMI, Nagoya-shi (JP); Makoto MIZUGUCHI, Toyota-shi (JP); Kenta KIMURA, Nagoya-shi (JP); Yasuhiro KOBATAKE, Nagoya-shi (JP)

(73) Assignee: TOYOTA JIDOSHA KABUSHIKI KAISHA, Toyota-shi (JP)

(21) Appl. No.: 19/247,945

(22) Filed: Jun. 24, 2025

(30) Foreign Application Priority Data
Jun. 27, 2024 (JP) 2024-103997

(51) Int. Cl. G06Q 20/10; G06Q 10/30

(52) U.S. Cl. CPC G06Q 20/102; G06Q 10/30

(57) ABSTRACT

An information processing apparatus managing information for a battery component constituting an on-board battery, the information processing apparatus comprises a controller configured to execute: accepting registration of information about a first battery component from a first user, the first battery component being a recycled battery component; accepting registration of information about a second battery component from a second user, the second battery component being a new battery component; and assigning an identifier as a new product to the information about the first battery component and assigning an identifier as a recycled product to the information about the second battery component when a transaction has been concluded between the first user and the second user.

### CROSS REFERENCE TO THE RELATED APPLICATION

This application claims the benefit of Japanese Patent Application No. 2024-103997, filed on Jun. 27, 2024, which is hereby incorporated by reference herein in its entirety.

### BACKGROUND

### Technical Field

The present disclosure relates to a vehicle technology.

### Description of the Related Art

There has been considered methods for reducing the cost of batteries in electric vehicles.

With regard to this, for example, Japanese Patent Laid-Open No. 2020-126305 discloses a management method for preventing increase in the price of batteries in electric vehicles.

### SUMMARY

An object of the present disclosure is to provide a technology for making a transaction for rights to recycled batteries.

The present disclosure in its one aspect provides an information processing apparatus managing information for a battery component constituting an on-board battery, the information processing apparatus comprising a controller configured to execute: accepting registration of information about a first battery component from a first user, the first battery component being a recycled battery component; accepting registration of information about a second battery component from a second user, the second battery component being a new battery component; and assigning an identifier as a new product to the information about the first battery component and assigning an identifier as a recycled product to the information about the second battery component when a transaction has been concluded between the first user and the second user.

The present disclosure in its another aspect provides an information processing method to be executed by an information processing apparatus, the information processing apparatus managing information for a battery component constituting an on-board battery, the information processing method comprising: accepting registration of information about a first battery component from a first user, the first battery component being a recycled battery component; accepting registration of information about a second battery component from a second user, the second battery component being a new battery component; and assigning an identifier as a new product to the information about the first battery component and assigning an identifier as a recycled product to the information about the second battery component when a transaction has been concluded between the first user and the second user.

As another aspect, a program for causing a computer to execute the above method or a computer-readable storage medium that stores the program in a non-transitory manner is given.

According to the present disclosure, it is possible to provide a technology for making a transaction for rights to recycled batteries.

### BRIEF DESCRIPTION OF THE DRAWINGS

FIG. 1 is an overview diagram of a system according to a first embodiment;

FIG. 2 is a hardware configuration diagram of a transaction server according to embodiments;

FIG. 3 is a hardware configuration diagram of a management server according to the embodiments;

FIG. 4 is a hardware configuration diagram of a business operator terminal according to the embodiments;

FIG. 5 is a software configuration diagram of the transaction server according to the embodiments;

FIG. 6 illustrates an example of a transaction ledger managed by the transaction server in the first embodiment;

FIG. 7 is a diagram for illustrating a transaction of rights;

FIG. 8 is a software configuration diagram of the management server according to the embodiments;

FIG. 9 illustrates an example of a component ledger managed by the management server in the first embodiment;

FIG. 10 is a software configuration diagram of the business operator terminal according to the embodiments;

FIG. 11 is a sequence diagram of a process for making a transaction of a battery component;

FIG. 12 is a flowchart of a process executed by the transaction server in the first embodiment; and

FIG. 13 is a flowchart of a process executed by the transaction server in a second embodiment.

### DESCRIPTION OF THE EMBODIMENTS

Recently, vehicles equipped with a drive battery and capable of traveling with electricity as an energy source, such as battery electric vehicles (BEV) and plug-in hybrid electric vehicles (PHEV), have been increasing in number.

It is anticipated that, when electric vehicles are more widespread, a business for sales/purchase of a drive battery (hereinafter, an on-board battery) removed from a used vehicle will be active. There is, however, a possibility that an on-board battery will be harmful to environment if it is not correctly recycled.

It is assumed that, in order to solve this problem, certain rules will be set for a method and a procedure for recycling an on-board battery in the future.

For example, it is assumed that a business operator will be obliged to, at the time of manufacturing on-board batteries, use a certain percentage of recycled battery components or more according to the scale of the business operator.

The battery components are components constituting an on-board battery and are, for example, a battery module, a battery cell, an electrode used for a battery cell, and the like.

When it becomes obligation to use a certain percentage of recycled battery component (hereinafter recycled components) or more, it is necessary for an on-board battery manufacturer to purchase recycled components according to the quantity of on-board batteries to be newly manufactured, from recyclers and transport the recycled components to a manufacturing factory. Therefore, there is a problem that, when it becomes obligation to use recycled components, components transportation costs increase, and on-board battery manufacturing costs increase. Furthermore, increase in transportation costs may lead to increase in the environmental load on the contrary.

The information processing apparatus in the present disclosure provides a technology for solving such a problem.

An information processing apparatus according to one aspect of the present disclosure is an information processing apparatus managing information for a battery component constituting an on-board battery, the information processing apparatus comprising a controller configured to execute: accepting registration of information about a first battery component from a first user, the first battery component being a recycled battery component; accepting registration of information about a second battery component from a second user, the second battery component being a new battery component; and assigning an identifier as a new product to the information about the first battery component and assigning an identifier as a recycled product to the information about the second battery component when a transaction has been concluded between the first user and the second user.

The information processing apparatus according to the present disclosure is an apparatus that manages transactions for battery components (for example, battery cells, parts constituting a battery cell, and the like) among users (Typically, business operators). The transactions may be such that transactions are accompanied by transfer of money or may be such that battery components are exchanged. In the case of exchanging battery components, a recycled battery component and a new battery component may be exchanged. In general, a recycled battery component is less valuable than a new battery component. It is, however, assumed that, in the case of being able to fulfill a legal obligation by using a recycled battery component, value is added to the recycled component. The transactions may be performed in consideration of the added value.

The information processing apparatus may be an apparatus that accepts registration of information about battery components from a plurality of users (business operators) desiring to make transactions, performs matching of business operators, and provides information for executing a transaction for each of the business operators.

The information processing apparatus according to the present disclosure accepts registration of information about a first battery component (a recycled product) from a first business operator, and accepts registration of information about a second battery component (a new product) from a second business operator. Then, when a transaction is concluded between both, the information processing apparatus assigns an identifier as a new product to the information about the first battery component, which is a recycled product, and assigns an identifier as a recycled product to the information about the second battery component, which is a new product.

The identifier as a recycled product may have been originally assigned to the information about the first battery component, and the identifier as a new product may have been originally assigned to the information about the second battery component. In this case, the identifiers of the battery components are mutually exchanged.

Each of the identifiers is, for example, information showing whether a target battery component is treated as a recycled product or a new product. The identifiers may be held by a center server that manages information about battery components of all the business operators.

For example, as for a battery component to which the identifier as a recycled product is assigned, a business operator obliged to “manufacture an on-board battery using a recycled product” can use the battery component to fulfill the obligation.

When the identifiers are exchanged between the first battery component which is a recycled product and the second battery component which is a new product, by the transaction described above, it becomes possible to use the second battery component to manufacture an on-board battery as a recycled product even though it is actually a new product. On the contrary, the first battery component related to the transaction is treated as a new product even though it is a recycled product. That is, after the transaction is completed, it is not possible to use the first battery component to fulfill the obligation described above. That is, the rights as a recycled product that originally could have been exercised are lost.

Thus, by using the information processing apparatus according to the present disclosure, it is possible to exchange only identifiers by a transaction. According to such a configuration, it becomes possible to transfer only rights accompanying a battery component which is a recycled product, without actually delivering the battery component. At the time of making the transaction, transfer of compensation from the second business operator to the first business operator may be performed.

The controller may further acquire proof data showing that the first battery component for which the transaction has been concluded has been incorporated in an on-board battery without rights as a recycled product being exercised.

For example, by assigning the identifier as a recycled product to the second battery component after confirming that the first battery component has been incorporated into an on-board battery as a new product by the proof data, it is possible to prevent duplicated exercise of rights. The proof data may be acquired, for example, from an external apparatus that manages manufacturing of on-board batteries.

When the transaction has been concluded between the first business operator and the second business operator, the controller may further transfer compensation from the second business operator to the first business operator. This is because the first business operator has lost the rights as a recycled product for the provided battery component. The compensation is, for example, compensation to the rights that the first business operator has lost. The transfer of the compensation may be executed on condition that the proof data described above has been acquired.

Furthermore, the controller may acquire conditions for the transaction from each of terminals corresponding to the first business operator and the second business operator, and perform matching of the first business operator and the second business operator based on the conditions.

The transaction may be not only a transaction for exchange of identifiers (a transaction not accompanied by delivery of a real battery component) but also a transaction accompanied by exchange of real battery components. The conditions for the transaction may include information about a delivery place, a delivery timing, compensation, and the like. The controller may perform matching of such business operators that mutually correspond in these conditions.

Specific embodiments of the present disclosure will be described below based on drawings. The hardware configuration, the module configuration, the functional configuration, and the like described in each embodiment are not intended to limit the technological scope of the present disclosure only thereto unless otherwise stated.

### First Embodiment

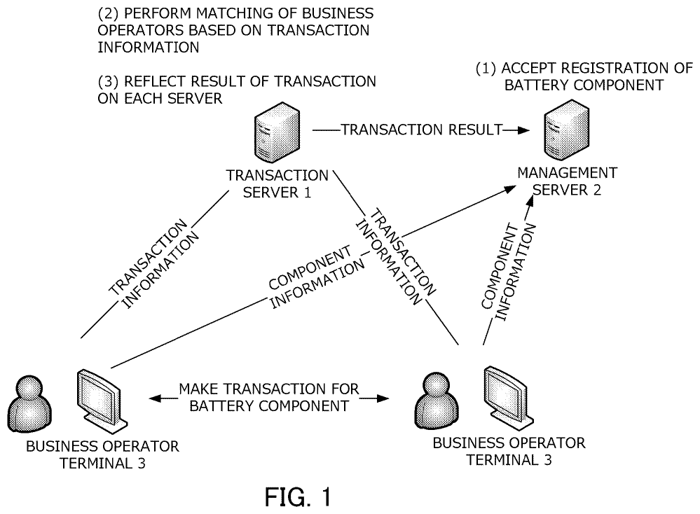

An overview of a system according to a first embodiment will be described with reference to FIG. 1. The system according to the present embodiment is a system that manages components for manufacturing battery packs that are designed for electric vehicles (battery components) and for making transactions for the battery components among business operators.

The battery pack is a unit obtained by adding a computer for control (an ECU) or the like to a drive battery for a vehicle. In order to manufacture a battery pack, it is necessary to use battery components such as a battery cell. The battery components may be new products or may be recycled products. For example, it is possible to, by disassembling a battery pack removed from a used vehicle and performing rebuilding, make a recycled battery cell.

It is conceivable to, when it becomes obligation to use a certain percentage of recycled products among battery components used to manufacture battery packs, make transactions for battery components among business operators. For example, it is conceivable that a business operator purchases battery components, which are recycled products, from another business operator to incorporate the recycled products into products of the business operator. The system according to the first embodiment supports such a transaction.

A transaction server 1 is a server apparatus that provides information for making transactions for battery components among business operators. For example, the transaction server 1 acquires information about battery components related to transactions from business operators desiring transactions and performs matching of business operators based on the information. Furthermore, the transaction server 1 provides information required for the transactions to the business operators.

A management server 2 is a server apparatus that manages the whole battery pack supply system. The management server 2 manages information about battery components held by business operators (for example, owners of the battery components, statuses of incorporation into battery packs, and the like). Furthermore, for each of the battery components under the control, the management server 2 manages information about whether the battery component is a recycled product or not by an identification label. For a given battery component, a third person can confirm the status of fulfillment of the recycled product use obligation by referring to the identification label of the battery component.

When a transaction is made between business operators, the transaction server 1 notifies the management server 2 of a result of the transaction (for example, change of the owner, change of the identification label, and the like), and the management server 2 updates the information.

Business operator terminals 3 are terminals held by business operators that make transactions for battery components, respectively. Each business operator registers information about battery components held by the business operator with the management server 2, using the business operator terminal 3. Furthermore, in the case of making a transaction for battery components, each business operator registers information required for the transaction with the transaction server 1 using the business operator terminal 3.

As illustrated in FIG. 1, each business operator that manufactures battery packs registers information about battery components held by the business operator (component information) with the management server 2 using the business operator terminal 3. Furthermore, each business operator that desires a transaction between business operators for battery components registers information about the transaction (transaction information) with the transaction server 1 using the business operator terminal 3.

The transaction server 1 performs matching of business operators based on the registered transaction information, and transmits information required for a transaction to the business operator terminal 3 of each business operator. In a case where a transaction is accompanied by transfer of money or a battery component, the transaction server 1 may mediate exchange of information about the settlement and information about the transfer of the battery component.

When a transaction is completed, the transaction server 1 notifies the management server 2 of a transaction result, and the management server 2 updates the information.

As stated before, the information about each battery component stored in the management server 2 is assigned an identification label indicating that the battery component is a recycled product (“an identifier as a recycled product” in the present disclosure) or an identification label indicating that the battery component is a new product (“an identifier as a new product” in the present disclosure).

The status of fulfillment of the recycling obligation imposed on business operators is judged based on the identification label. That is, when a battery pack is manufactured using a battery component that is assigned the identification label as a recycled product, it is assumed that the recycling obligation has been fulfilled.

In addition to a normal transaction accompanied by transfer of a battery component, the transaction server 1 can mediate a transaction for only exchange of identification labels without transfer of a battery component. When identification labels are to be changed as a result of a transaction, the transaction server 1 transmits a transaction result to the effect that the identification labels are to be changed, to the management server 2, and, in response thereto, the management server 2 updates the identification labels of corresponding battery components.

According to such a configuration, it becomes possible to make a transaction for only rights accompanying a battery component which is a recycled product, without actually delivering the battery component.

### [Hardware Configuration]

Next, the hardware configuration of each apparatus constituting the system will be described.

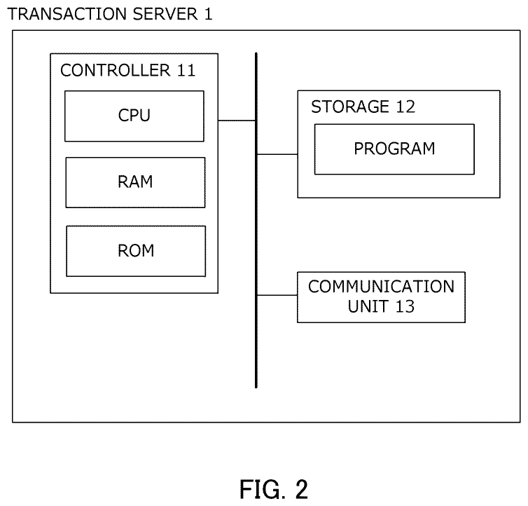

First, components of the transaction server 1 will be described. FIG. 2 is a diagram schematically illustrating an example of the hardware configuration of the transaction server 1.

The transaction server 1 can be configured as a computer that includes a processor (a CPU, a GPU, or the like), a main memory (a RAM, a ROM, and the like), and an auxiliary storage device (an EPROM, a hard disk drive, a removable medium, or the like). In the auxiliary storage device, an operating system (OS), various kinds of programs, various kinds of tables, and the like are stored. By executing a program stored in the auxiliary storage device, each of functions (software modules) that meet predetermined purposes as described later can be realized. A part or all of the functions, however, may be realized as hardware modules by a hardware circuit, for example, an ASIC or an FPGA.

The transaction server 1 is configured, including a controller 11, a storage 12, and a communication unit 13.

The controller 11 is an arithmetic unit that realizes the various functions of the transaction server 1 by executing a predetermined program. The controller 11 can be realized, for example, by a hardware processor such as a CPU. Furthermore, the controller 11 may be configured, including a RAM, a read-only memory (ROM), a cache memory, and the like.

The storage 12 is means for storing information and is configured, including a main memory and an auxiliary storage device. The main memory is a memory where a program executed by the controller 11 and data used by the control program are developed. The auxiliary storage device is a device in which the program executed by the controller 11 and the data used by the control program are stored. In the auxiliary storage device, what is obtained by packaging the program executed by the controller 11 as an application may be stored. An operating system for executing such an application may be stored. By the program stored in the auxiliary storage device being loaded to the main memory and executed by the controller 11, processes described later is performed.

As the main memory, a random-access memory (RAM) and a read-only memory (ROM) may be included. As the auxiliary storage device, an erasable programmable ROM (EPROM) or a hard disk drive (HDD) may be included. Furthermore, as the auxiliary storage device, a removable medium, that is, a portable recording medium may be included.

The communication unit 13 is a communication interface for connecting the transaction server 1 to a network. The communication unit 13 may be a wired communication interface or may be a wireless communication interface.

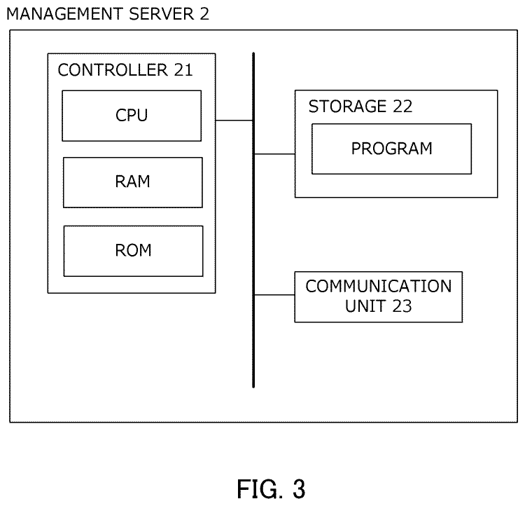

Next, components of the management server 2 will be described. FIG. 3 is a diagram schematically illustrating an example of the hardware configuration of the management server 2.

The management server 2 can be configured as a computer that includes a processor (a CPU, a GPU, or the like), a main memory (a RAM, a ROM, and the like), and an auxiliary storage device (an EPROM, a hard disk drive, a removable medium, or the like). In the auxiliary storage device, an operating system (OS), various kinds of programs, various kinds of tables, and the like are stored. By executing a program stored in the auxiliary storage device, each of functions (software modules) that meet predetermined purposes as described later can be realized. A part or all of the functions, however, may be realized as hardware modules by a hardware circuit, for example, an ASIC or an FPGA.

The management server 2 is configured, including a controller 21, a storage 22, and a communication unit 23.

The controller 21 is an arithmetic unit that realizes the various functions of the management server 2 by executing a predetermined program. The controller 21 can be realized, for example, by a hardware processor such as a CPU. Furthermore, the controller 21 may be configured, including a RAM, a read-only memory (ROM), a cache memory, and the like.

The storage 22 is means for storing information and is configured, including a main memory and an auxiliary storage device. The main memory is a memory where a program executed by the controller 21 and data used by the control program are developed. The auxiliary storage device is a device in which the program executed by the controller 21 and the data used by the control program are stored. In the auxiliary storage device, what is obtained by packaging the program executed by the controller 21 as an application may be stored. An operating system for executing such an application may be stored. By the program stored in the auxiliary storage device being loaded to the main memory and executed by the controller 21, a process described hereinafter is performed.

As the main memory, a random-access memory (RAM) and a read-only memory (ROM) may be included. As the auxiliary storage device, an erasable programmable ROM (EPROM) or a hard disk drive (HDD) may be included. Furthermore, as the auxiliary storage device, a removable medium, that is, a portable recording medium may be included.

The communication unit 23 is a communication interface for connecting the management server 2 to a network. The communication unit 23 may be a wired communication interface or may be a wireless communication interface.

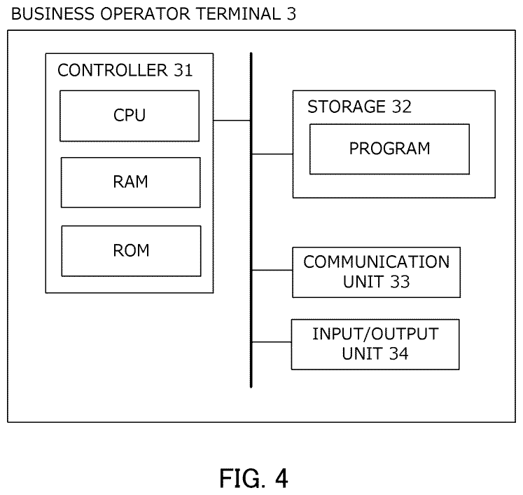

Next, components of each business operator terminal 3 will be described. FIG. 4 is a diagram schematically illustrating an example of the hardware configuration of the business operator terminal 3.

The business operator terminal 3 can be configured as a computer that includes a processor (a CPU, a GPU, or the like), a main memory (a RAM, a ROM, and the like), and an auxiliary storage device (an EPROM, a hard disk drive, a removable medium, or the like) similarly to the transaction server 1.

The business operator terminal 3 is configured, including a controller 31, a storage 32, a communication unit 33, and an input/output unit 34.

The controller 31 is an arithmetic unit that realizes the various functions of the business operator terminal 3 by executing a predetermined program. The controller 31 can be realized, for example, by a hardware processor such as a CPU. Furthermore, the controller 31 may be configured, including a RAM, a read-only memory (ROM), a cache memory, and the like.

The storage 32 is means for storing information and is configured with a storage medium such as a RAM, a magnetic disk, or a flash memory. In the storage 32, the program executed by the controller 31 and data and the like used by the program are stored.

The communication unit 33 is a communication interface for connecting the business operator terminal 3 to a network. The communication unit 33 may be a wired communication interface or may be a wireless communication interface.

The input/output unit 34 is a unit that accepts an input from an operator of the business operator terminal 3 and presents information to the operator. Specifically, the input/output unit 34 is configured with a touch panel and control means therefor, and a liquid crystal display and control means therefor. In the present embodiment, the touch panel and the liquid crystal display are configured with one touch panel display. The input/output unit 34 may include hardware interfaces such as a keyboard and a mouse.

### [Software Configuration]

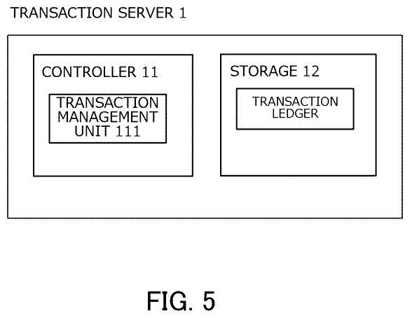

Next, the software configuration of each apparatus constituting the system will be described. FIG. 5 is a diagram schematically illustrating the software configuration of the transaction server 1 according to the present embodiment.

In the present embodiment, the controller 11 of the transaction server 1 is configured, including a transaction management unit 111 as a software module. The software module may be realized by executing a program stored in the storage 12 described later by the controller 11 (a CPU or the like). Information processing executed by the software module is synonymous with information processing executed by the controller 11 (a CPU or the like).

The transaction management unit 111 manages mutual transactions for battery components among business operators.

The transaction management unit 111 receives information about a transaction for battery components (transaction information) from the business operator terminals 3 and stores the information into a transaction ledger in the storage 12.

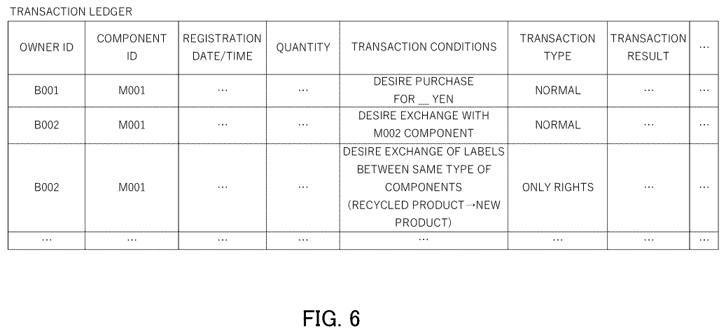

FIG. 6 illustrates an example of the transaction ledger. The transaction ledger is a database for managing transactions. The transaction management unit 111 that has received the information from the business operator terminals 3 generates records corresponding to the business operators in the transaction ledger.

The transaction ledger is configured, including “owner ID”, “component ID”, “registration date/time”, “quantity”, “transaction conditions”, “transaction type”, and “transaction result” fields.

In each owner ID field, an identifier that indicates the current owner of a battery component is stored. In each component ID field, an identifier that uniquely identifies a battery component is stored. In each transaction conditions field, information showing transaction conditions desired by a business operator involved in a transaction is stored.

In each transaction type field, information showing the type of transaction is stored. In the present embodiment, there are two types of transactions, “normal” and “only rights”. Here, “normal” means a normal transaction accompanied by movement of a battery component/battery components. For example, in the case of exchanging battery components or in the case of selling/buying a battery component with money, the transaction type is “normal”.

Furthermore, “only rights” means a transaction for replacing identification labels assigned to battery components in the management server 2 (hereinafter referred to as a transaction for rights).

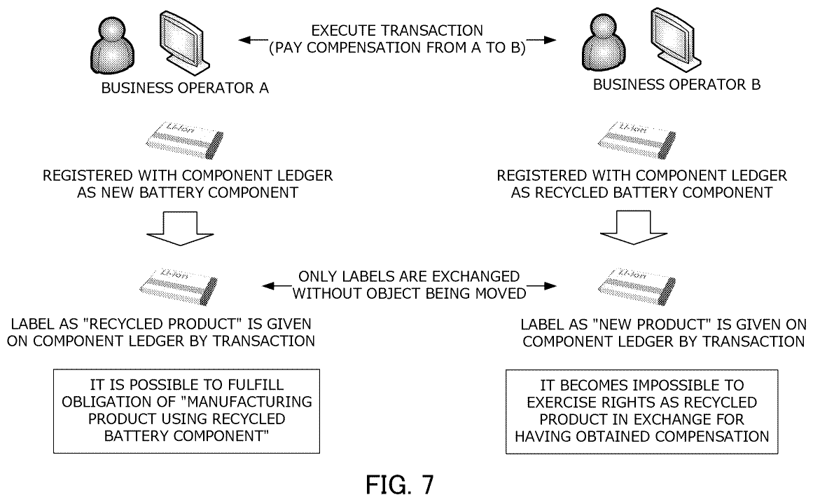

Here, a specific example of the transaction for rights will be described with reference to FIG. 7. Here, it is assumed that a business operator A owns a battery component which is a new product, and a business operator B owns a battery component which is a recycled product. The battery component owned by the business operator A is registered as a new product in the management server 2. The battery component owned by the business operator B is registered as a recycled product in the management server 2.

The business operators A and B execute a transaction for exchanging identification labels. For example, the business operator A pays compensation to the business operator B, and the identification label as a recycled product is transferred from the battery component owned by the business operator B to the battery component owned by the business operator A. Furthermore, the identification label as a new product is transferred from the battery component owned by the business operator A to the battery component owned by the business operator B.

When this transaction is completed, the identification label as a recycled product is assigned to the battery component owned by the business operator A, and the identification label as a new product is assigned to the battery component owned by the business operator B. That is, the identification labels have been exchanged.

Thereby, it becomes possible for the business operator A to fulfill the obligation of “manufacturing a battery pack using a battery component which is a recycled product” by using the battery component the business operator A owns.

In each transaction result field, information about the situation of a transaction (for example, “unmatched”, “matched”, “transaction completed”, or the like) is stored.

The transaction management unit 111 extracts, from among the records of the trading ledger, such records that the value of the transaction result field indicates that a transaction has not been made, and performs matching of business operators. At this time, the transaction management unit 111 performs matching for each transaction type. That is, for a record in which “normal” is set as the transaction type, matching with a record in which “normal” is set as the transaction type is performed. For a record in which “only rights” is set as the transaction type, matching with a record in which “only rights” is set as the transaction type is performed.

Results of matching are transmitted to business operator terminals 3, and transactions (for example, transfer of money or a battery component) are executed.

Further the transaction management unit 111 updates a component ledger by acquiring information about results of transactions from the business operator terminals 3 and notifying the management server 2 of the transaction results. For example, when battery components have been exchanged, and the owners of the battery components have changed as a result of a transaction, the transaction management unit 111 notifies the management server 2 to that effect, and, in response thereto, the management server 2 updates the component ledger. When the transaction type is “only rights”, the transaction management unit 111 instructs the management server 2 to replace (exchange) identification labels, and, in response thereto, the management server 2 updates the component ledger.

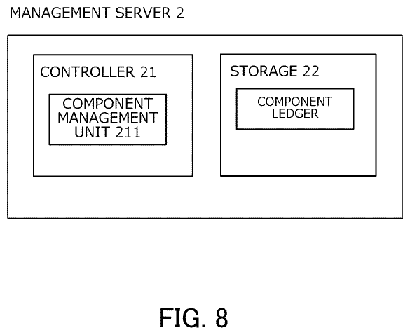

Next, the software configuration of the management server 2 will be described. FIG. 8 is a diagram schematically illustrating the software configuration of the management server 2 according to the present embodiment.

The controller 21 of the management server 2 is configured, including a component management unit 211 as a functional module. The functional module may be realized by executing a stored program by the CPU.

The component management unit 211 manages the component ledger stored in the storage 22.

Specifically, the component management unit 211 receives information about battery components to be newly registered (component information) from the business operator terminals 3 and stores the information into the component ledger.

In the component ledger, the owner of each battery component, the status of the battery component (for example, whether being incorporated in a product or not), and the like are recorded, and the content is updated as necessary according to a situation. By referring to the component ledger, it is possible to follow battery components in a supply chain.

When a transaction for a battery component is made, the component management unit 211 acquires information about a result of the transaction from the transaction server 1 and updates the component ledger based thereon. For example, when receiving a notification to the effect that “the owner of a given battery component has changed as a result of a transaction” from the transaction server 1, the component management unit 211 updates the owner on the component ledger. When receiving a notification to the effect that “the identification labels of given battery components have been exchanged a result of a transaction” from the transaction server 1, the component management unit 211 updates the identification labels of the battery components concerned.

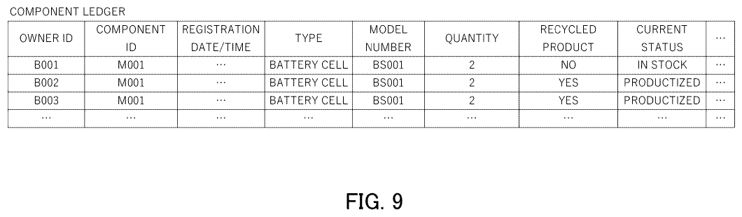

FIG. 9 illustrates an example of the component ledger. The component ledger is a database for managing battery components in the supply chain. In the component ledger, information about battery components owned by business operators is recorded.

The component ledger is configured, including “owner ID”, “component ID”, “registration date/time”, “type”, “model number”, “quantity”, “recycled product”, and “current status” fields.

In each owner ID field, an identifier that indicates the current owner of a battery component is stored. In each component ID field, an identifier that uniquely identifies a battery component is stored.

In each recycled product field, a value indicating whether a corresponding battery component is treated as a recycled product or not is stored. In the present embodiment, when the value of the recycled product field is “YES”, it means that, for a corresponding battery component, the right as a recycled product can be exercised. When the value of the recycled product field is “NO”, it means that, for a corresponding battery component, the right as a recycled product cannot be exercised.

That the value stored in the recycled product field is “YES” means that “the identifier as a recycled product is assigned” to information about a corresponding battery component. That the value of the recycled product field is “NO” means that “the identifier as a new product is assigned” to the information about a corresponding battery component.

In the present embodiment, “assigning the identification label as a recycled product” refers to setting “YES” as the value of the recycled product field, and “deleting the identification label as a recycled product” refers to setting “NO” as the value of the recycled product field.

In each current status field, information showing in which form a corresponding battery component currently exists (for example, whether existing as a single component or existing in a state of being processed as a product) is stored. When the supply chain has a plurality of hierarchical layers, at which hierarchical layer the corresponding battery component is located may be managed by the component ledger.

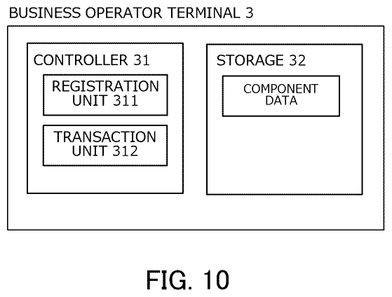

Next, the software configuration of each business operator terminal 3 will be described. FIG. 10 is a diagram schematically illustrating the software configuration of the business operator terminal 3 according to the present embodiment.

The controller 31 of the business operator terminal 3 is configured, including a registration unit 311 and a transaction unit 312 as functional modules. Each functional module may be realized by executing a stored program by the CPU.

The registration unit 311 accepts input of information about battery components to be newly registered, via the input/output unit 34, and transmits the inputted information to the management server 2 as component information. The transmitted information is registered with the component ledger on the management server 2.

The transaction unit 312 accepts input of information about transactions for battery components among business operators (for example, information about the battery components to be provided, transaction conditions, and the like) and transmits the inputted information to the transaction server 1 as transaction information. Furthermore, the transaction unit 312 acquires information about the transactions transmitted from the transaction server 1 and outputs the information. The transaction unit 312 may accept input of information about results of the transactions (for example, to the effect that delivery of a battery component has been completed) and transmit the information to the transaction server 1.

Note that the configurations illustrated in FIGS. 2 to 5 and FIGS. 8 and 10 are examples, and all or a part of the illustrated functions may be executed with dedicatedly designed circuits. Furthermore, storage and execution of the program may be performed by a combination of a main memory and an auxiliary storage device other than the illustrated combination.

### [Sequence Diagram]

Next, a process executed by each apparatus included in the system will be described.

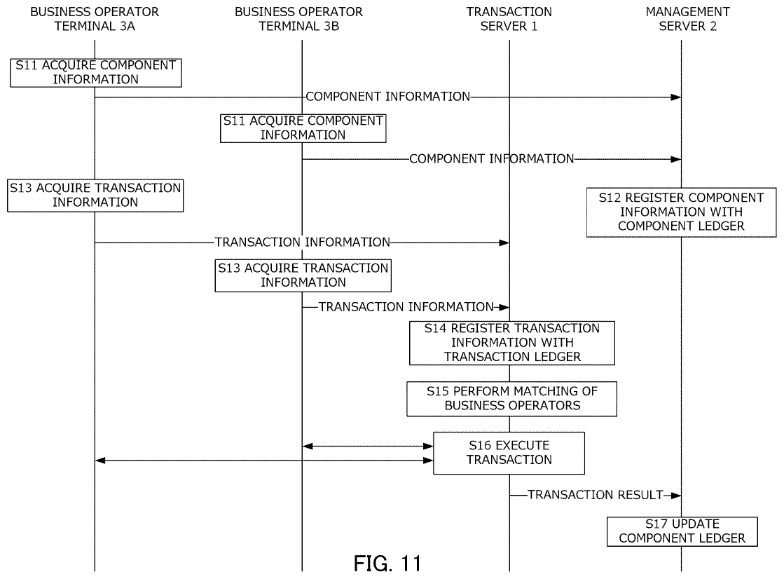

FIG. 11 is a sequence diagram of a process for a plurality of business operators holding battery components to register pieces of information about the battery components (component information) with the management server 2 and a process for the business operators to make a transaction for the battery components between them using the transaction server 1. The illustrated process sequence is started at the timing when each business operator procures a battery component.

Here, the business operators that make the transaction will be referred to as a business operator A and a business operator B. Furthermore, the business operator terminal used by the business operator A will be referred to as “a business operator terminal 3A”, and the business operator terminal used by the business operator B will be referred to as “a business operator terminal 3B”.

First, in step S11, the business operator terminals 3A and 3B acquire pieces of information about battery components (pieces of component information) held by the business operators, respectively. Each business operator terminal may accept input of the piece of component information from an operator of the apparatus. As illustrated in FIG. 9, the component information includes detailed information about the battery component, and information showing whether the battery component is a recycled product or not.

The inputted pieces of component information are transmitted to the transaction server 1 and registered with the component ledger (step S12).

Next, in step S13, each of the business operator terminals 3A and 3B acquires information about a transaction for the battery component (transaction information). Each business operator terminal may accept input of the transaction information from the operator of the apparatus. The transaction information includes, for example, information about specification of the battery component related to the transaction, transaction conditions (for example, specification of the target object, specification of a price, and specification of a delivery date), and the like.

The inputted transaction information is transmitted to the transaction server 1 and registered with the transaction ledger (step S14).

The transaction server 1 compares records registered with the transaction ledger at predetermined timings and executes a process for performing matching of business operators (step S15). In this process, for example, the transaction server 1 extracts pairs of business operators with mutually matching transaction conditions, and decides a combination to actually make a transaction. When there are a plurality of candidates for the combination, the transaction server 1 may combine business operators with better conditions.

When a combination is decided, the transaction server 1 performs a process for executing a transaction (step S16). At this step, the transaction server 1 provides information about execution of the transaction for each business operator terminal 3 and acquires a result. At this step, for example, information about a transaction counterpart, information about a settlement status, information about a battery component transfer status, information showing a contract fulfillment status, and the like are exchanged between the transaction server 1 and each business operator terminal 3. When the transaction is completed, the business operator terminals 3 may transmit data showing that the transaction has been completed to the transaction server 1.

When acquiring the data showing that the transaction has been completed, from the business operator terminals 3, the transaction server 1 notifies the management server 2 of the result, and, in response thereto, the management server 2 updates the component ledger (step S17).

For example, when a battery component itself has been delivered by the transaction, the value of the “owner” field of a corresponding record in the component ledger is updated. When identification labels are exchanged by a transaction, the values of the “recycled product” fields of corresponding records in the component ledger are updated.

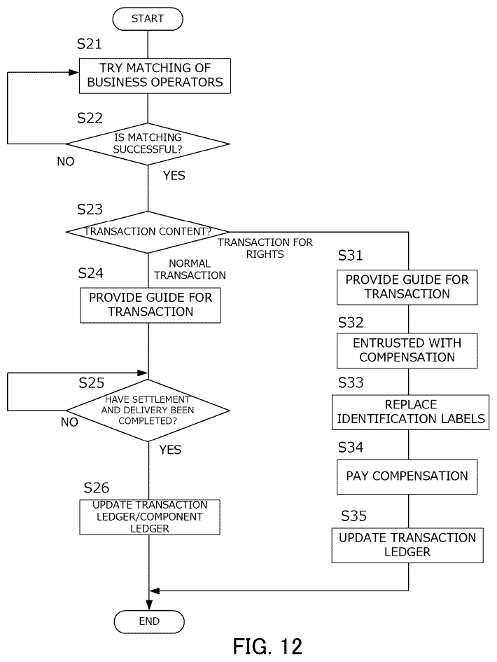

FIG. 12 is a flowchart illustrating the details of the process executed by the transaction server 1 (the transaction management unit 111) at and after step S15 illustrated in FIG. 11.

First, in step S21, matching of business operators is tried based on the transaction ledger. At this step, pairs of business operators with mutually matching transaction conditions are extracted, and, after evaluating whether the pairs are appropriate as a combination to actually make a transaction, matching targets are decided. As a result, if matching is successful (step S22: Yes), the process transitions to step S23. If matching fails (step S22: No), matching is tried again after waiting for a predetermined time. If matching is not successful even a predetermined period elapses, the process may be discontinued.

If matching is successful, it is possible to assume that a transaction between the business operators has been concluded.

The subsequent process differs depending on whether the target transaction is a transaction accompanied by battery component delivery (hereinafter “a normal transaction”) or a transaction not accompanied by battery component delivery (hereinafter “a transaction for rights”). In step S23, the type of the target transaction is judged. If the target transaction is a normal transaction, the process transitions to step S24. If the target transaction is a transaction for rights, the process transitions to step S31.

In step S24, the transaction server 1 generates a guide for the transaction and transmits the guide to each of the business operator terminals 3A and 3B. The guide may include information about the transaction counterpart and a guide for a battery component delivery method, a settlement method, and the like. In step S25, the transaction server 1 judges whether battery component delivery and settlement have been completed or not, based on data received from the business operator terminal 3A and 3B. As for the settlement, the transaction server 1 may mediate it.

If the battery component delivery and settlement have been completed, the process transitions to step S26.

In step S26, the transaction server 1 reflects the result of the transaction on the transaction ledger. For example, at this step, data to the effect that the transaction has been completed is written in a corresponding transaction result field of the transaction ledger. Furthermore, at this step, the transaction server 1 notifies the management server 2 of the transaction result. If the target transaction is a normal transaction, the management server 2 updates the value of a corresponding owner field of the component ledger.

If the target transaction is a transaction for rights, the transaction server 1 generates a guide for the transaction and transmits the guide to each of the business operator terminals 3A and 3B in step S31, similarly to step S24. The guide may include information about the transaction counterpart and a guide for a settlement method and the like.

Next, in step S32, the transaction server 1 is entrusted with compensation accompanying exchange of the identification labels from one business operator. The compensation may be received by electronic settlement. In this case, for example, the business operator A may perform a procedure for settlement of compensation to be paid to the business operator B and transfer the balance to the transaction server 1.

Next, in step S33, the transaction server 1 requests the management server 2 to replace the identification labels of the battery components related to the transaction. Specifically, the transaction server 1 causes a process for assigning a recycle flag to the record of the battery component held by the business operator A, which is included in the component ledger, to be performed, and causes a process for deleting a recycle flag from the record of the battery component held by the business operator B to be performed. At this step, data other than the recycle flag may be updated as necessary.

When replacement of the identification labels is completed, the process transitions to step S34, where the transaction server 1 pays the compensation accompanying the exchange of the identification labels to the business operator that is a receiver. When the compensation is received by electronic settlement, the transaction server 1 performs, for example, a procedure for transferring the compensation (the balance) entrusted from the business operator A to the business operator B.

In step S35, the transaction server 1 reflects the result of the transaction on the transaction ledger. For example, at this step, data to the effect that the transaction has been completed is written in a corresponding transaction result field of the transaction ledger.

As described above, in addition to mediating a normal transaction in which battery component delivery occurs, the transaction server 1 according to the present embodiment can mediate a transaction for only rights in which battery component delivery does not occur. Thereby, it becomes possible to cause only rights accompanying a battery component which is a recycled product to be a transaction target, and can prevent unnecessary battery component transportation costs.

### Second Embodiment

In the first embodiment, replacement of identification labels is performed for transaction target battery components at a timing when payment of compensation from one business operator is confirmed. In the first embodiment, however, a problem may occur that it is not possible to confirm in which form a battery component for which a transaction was made has been actually productized.

For example, in the case of the example of FIG. 7, though the identification label of the battery component owned by the business operator B is changed from “recycled product” to “new product” by the transaction, it is not possible to confirm that this battery component has been actually incorporated into a battery pack as a new product.

Depending on the transaction timing, there may be a case where the battery component becomes a transaction target as a recycled product even though the rights as a recycled product have been already exercised. For example, a case where transaction information is registered during manufacture of a battery pack is the case.

In such a case, there is a possibility that the rights are duplicately exercised.

In order to solve this problem, the transaction server 1 according to a second embodiment acquires data that proves that a battery component related to a transaction has been incorporated into a product (a battery pack) without the rights as a recycled product being exercised (hereinafter proof data), and completes a transaction on condition that the proof data has been acquired.

During a transaction for a battery component, the transaction server 1 acquires the data showing that a battery component related to a transaction has been incorporated into a product (a battery pack) without the rights as a recycled product being exercised (the proof data) from an external apparatus. The proof data may be generated, for example, by a third party that supervises use of battery components by business operators. The proof data may be a mere value or may be a verifiable electronic certificate or the like. Until the proof data is acquired, a transaction is in a pending state.

When the proof data is acquired, the transaction server 1 completes the transaction in the pending state and reflects the content of the transaction on the component ledger.

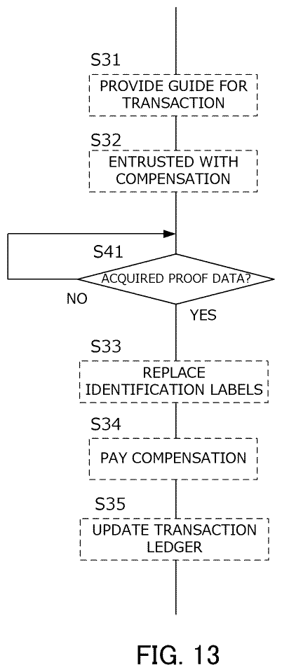

FIG. 13 is a flowchart of a part extracted from the process illustrated in FIG. 12, the part being changed in the second embodiment. In the present embodiment, a step of acquiring proof data (step S41) is executed after step S32 being executed. At this step, the management server 2 tries to acquire proof data from an external apparatus or the like. If a positive judgment is made at this step, that is, the proof data can be normally acquired, the process proceeds to step S33. If a negative judgment is made at this step, that is, the proof data cannot be acquired, the management server 2 repeats the process of S41. If the proof data cannot be acquired even if a predetermined period elapses, the transaction may be cancelled.

The process at and after step S33 is similar to that of the first embodiment.

According to the second embodiment, since it is possible to complete a transaction after confirming in which form a transaction target battery component has been actually productized, it is possible to prevent the problem that duplicated exercise of rights may occur.

### Modification

The above embodiments are mere examples, and the present disclosure can be appropriately changed and implemented within a range not departing from its spirit.

For example, the processes and means described in the present disclosure can be freely combined and implemented as far as technical contradiction does not occur.

Furthermore, the processes described as being performed by one device may be shared and executed by a plurality of devices. Alternatively, the processes described as being performed by different devices may be performed by a single device. In a computer system, the hardware configuration (server configuration) by which each function is realized can be flexibly changed.

The present disclosure can also be realized by supplying a computer program implementing the functions described in the above embodiments to a computer, and having one or more processors of the computer read and execute the program. Such a computer program may be provided to the computer by a non-transitory computer-readable storage medium connectable to the system bus of the computer, or may be provided to the computer via a network. Non-transitory computer-readable storage media include, for example, any type of disk, such as a magnetic disk (e.g., a floppy disk, a hard disk drive (HDD), etc.), an optical disk (e.g., a CD-ROM, a DVD disk, a Blu-ray disk, etc.), a read-only memory (ROM), a random-access memory (RAM), an EPROM, an EEPROM, a magnetic card, a flash memory, an optical card, or any type of medium suitable for storing electronic instructions.

What is claimed is:

1. An information processing apparatus managing information for a battery component constituting an on-board battery, the information processing apparatus comprising a controller configured to execute:
receiving first data regarding a first battery component from an apparatus of a first user, the first battery component being a recycled battery component;
receiving second data regarding a second battery component from an apparatus of a second user, the second battery component being a new battery component; and
recording an identifier as a new product to the first data regarding the first battery component and recording an identifier as a recycled product to the second data regarding the second battery component, when predetermined information related to the first user and the second user has been generated.

2. An information processing apparatus managing information for a battery component constituting an on-board battery, the information processing apparatus comprising a controller configured to execute:
accepting registration of information about a first battery component from a first user, the first battery component being a recycled battery component;
accepting registration of information about a second battery component from a second user, the second battery component being a new battery component; and
assigning an identifier as a new product to the information about the first battery component and assigning an identifier as a recycled product to the information about the second battery component, when a transaction has been concluded between the first user and the second user.

3. The information processing apparatus according to claim 2,
wherein the controller
assigns the identifier as a recycled product to the information about the first battery component when accepting the registration of the information about the first battery component and assigns the identifier as a new product to the information about the second battery component when accepting the registration of the information about the second battery component.

4. The information processing apparatus according to claim 2,
wherein the controller
further acquires proof data showing that the first battery component has been incorporated in an on-board battery without rights as a recycled product being exercised.

5. The information processing apparatus according to claim 4,
wherein the controller
assigns the identifier as a recycled product to the information about the second battery component on condition that the proof data has been acquired.

6. The information processing apparatus according to claim 2,
wherein, the controller further transfers compensation from the second user to the first user.

7. The information processing apparatus according to claim 2,
wherein the controller
further acquires proof data showing that the first battery component has been incorporated in an on-board battery without rights as a recycled product being exercised, and
assigns the identifier as a recycled product to the information about the second battery component on condition that the proof data has been acquired, and transfers compensation from the second user to the first user.

8. The information processing apparatus according to claim 2,
wherein the controller acquires designated conditions from each of terminals corresponding to the first user and the second user, and performs matching of the first user and the second user based on the conditions.

9. The information processing apparatus according to claim 8,
wherein the conditions include compensation transferred from the second user to the first user.

10. An information processing method to be executed by an information processing apparatus, the information processing apparatus managing information for a battery component constituting an on-board battery, the information processing method comprising:
accepting registration of information about a first battery component from a first user, the first battery component being a recycled battery component;
accepting registration of information about a second battery component from a second user, the second battery component being a new battery component; and
assigning an identifier as a new product to the information about the first battery component and assigning an identifier as a recycled product to the information about the second battery component when a transaction has been concluded between the first user and the second user.

11. The information processing method according to claim 10,
wherein the identifier as a recycled product is assigned to the information about the first battery component when the registration of the information about the first battery component is accepted, and the identifier as a new product is assigned to the information about the second battery component when the registration of the information about the second battery component is accepted.

12. The information processing method according to claim 10,
wherein the information processing apparatus
further acquires proof data showing that the first battery component has been incorporated in an on-board battery without rights as a recycled product being exercised.

13. The information processing method according to claim 12,
wherein the information processing apparatus
assigns the identifier as a recycled product to the information about the second battery component on condition that the proof data has been acquired.

14. The information processing method according to claim 10,
wherein, the information processing apparatus transfers compensation from the second user to the first user.

15. The information processing method according to claim 10,
wherein the information processing apparatus
further acquires proof data showing that the first battery component has been incorporated in an on-board battery without rights as a recycled product being exercised, and
assigns the identifier as a recycled product to the information about the second battery component on condition that the proof data has been acquired, and transfers compensation from the second user to the first user.

16. The information processing method according to claim 10,
wherein the information processing apparatus
acquires designated conditions from each of terminals corresponding to the first user and the second user, and performs matching of the first user and the second user based on the conditions.

17. The information processing method according to claim 16,
wherein the conditions include compensation transferred from the second user to the first user.

18. A non-transitory computer readable storing medium recording a computer program for causing a computer to perform an information processing method according to claim 10.
